(19) United States
(12) Patent Application Publication
(10) Pub. No.: US 2018/0358677 A1
(43) Pub. Date: Dec. 13, 2018

(54) WAVEGUIDE-TO-MICROSTRIP TRANSITION

(71) Applicant: Limited Liability Company "Radio Gigabit", Nizhny Novgorod (RU)

(72) Inventors: Aleksey Andreevich ARTEMENKO, Nizhniy Novgorod (RU); Roman Olegovich MASLENNIKOV, Nizhniy Novgorod (RU); Andrey Viktorovich MOZHAROVSKIY, Nizhniy Novgorod (RU); Oleg Valer'evich SOYKIN, Nizhniy Novgorod (RU); Vladimir Nikolaevich SSORIN, Nizhniy Novgorod (RU)

(21) Appl. No.: 15/765,432

(22) PCT Filed: Oct. 3, 2016
(86) PCT No.: PCT/RU2016/000659

§ 371 Date: Jul. 25, 2018

(30) Foreign Application Priority Data
Oct. 2, 2015 (RU) 2015141953

(51) Int. Cl. H01P 5/107; H01P 1/04; H01Q 1/50; H01Q 13/10

(52) U.S. Cl. CPC H01P 5/107; H01Q 13/106; H01Q 1/50; H01P 1/042

(57) ABSTRACT

The invention relates to microwave technology and can be used in measuring technology and wireless communication. The technical result is a waveguide-to-microstrip transition which provides reduced signal transmission losses and increased working bandwidth together with a low wave reflection coefficient. A contacting metal layer is arranged on an upper surface of a dielectric circuit board around a micro-strip probe, without electrical contact with the micro-strip probe and a micro-strip transmission line and forming an internal area on the dielectric circuit boar being a waveguide channel area. A closed waveguide section having a slot in the area of the microstrip transmission line is arranged on the contacting metal layer. At least one metallized transition through-hole is formed along a perimeter around the area of the waveguide channel in the metal layers and in the dielectric circuit board, and at least one non-metallized through-hole is formed inside the waveguide channel area.

### FIELD OF THE INVENTION

The present invention generally relates to the field of microwave frequency devices and more specifically to waveguide-to-microstrip transitions which provide effective transfer of electromagnetic energy between a metal waveguide and a microstrip line realized on a dielectric board. The invention can be used in measurement equipment, antenna systems and in various wireless communication systems and radars.

### BACKGROUND OF THE INVENTION

One of the trends in modern wireless communication systems is frequency band extension with simultaneous carrier frequency shift to the millimeter-wave range. In the millimeter-wave region (30-300 GHz) of electromagnetic spectrum, such applications as indoor local radio networks, radio relay links, automotive radars, microwave imaging devices etc. are already successfully used. For example, communication systems operating in the millimeter-wave range provide significant improvement in data transmission throughput of up to several and even tens of Gb/sec.

Millimeter-wave communication systems and radars only recently found widespread use due to developments in semiconductor technology and possibility of Transmitter/Receiver (Tx/Rx) implementation on semiconductor integrated circuits (IC) instead of traditional waveguide components of discrete functional parts. Such ICs are usually mounted on dielectric boards, thus forming fully integrated devices. The interconnection between ICs on a dielectric board in most cases is realized by microstrip transmission lines. Meanwhile, some elements of radio devices (for instance, antennas) should principally comprise waveguide interfaces to provide required characteristics (for example, high gain, low loss or high radiated power in case of antennas).

Thus, in order to provide efficient function, millimeter-wave communication systems require an effective waveguide-to-microstrip transition for electromagnetic signal transfer in any direction between a waveguide and a planar transmission line realized on a dielectric board. Moreover, in addition to radio communication systems and radars, such transitions are used in microwave measurement equipment where waveguides are utilized as low-loss transmission lines.

General requirements to waveguide-to-microstrip transitions for modern millimeter-wave communication systems include wide operational bandwidth, low level of insertion loss, low fabrication cost in mass production and simple construction for easy integration of the transition into the communication device.

Some configurations of known waveguide-to-microstrip transitions which can be used in millimeter-wave devices are considered below.

A waveguide-to-microstrip line transition based on a stepped waveguide structure (so-called “ridged waveguide”) is known from the paper “A Novel Waveguide-to-Microstrip Transition for Millimeter-Wave Module Applications” written by Villegas, F. J., Stones, D. I., Hung, H. A. published in IEEE Transactions on Microwave Theory and Techniques, Vol. :47, Issue 1, January 1999. A dielectric board with a microstrip line is positioned along the waveguide longitudinal axis. The line is electrically connected to the highest step of the ridged waveguide. Drawbacks of such transition include high complexity and therefore high manufacturing cost. Furthermore, there are some issues related to the positioning of the board in the waveguide channel leading to worse performance and poor repeatability. These disadvantages are further amplified with the increase of operational frequencies to the millimeter-wave range.

Another waveguide-to-microstrip transition (“Design of Wideband Waveguide to Microstrip Transition for 60 GHz Frequency Band” written by Artemenko A., Maltsev A., Maslennikov R., Sevastyanov A., Ssorin V., published in proc. of 41st European Microwave Conference, 10-13 October 2011) is based on a planar radiating element placed inside an aperture of a waveguide channel. The electromagnetic coupling between the radiating element and the microstrip line is provided by a slot cut in the metal ground layer of the microstrip line. The transition is relatively narrowband due to the resonance nature of the slot and the radiating element. Moreover, such transition requires several dielectric layers on the board, thus increasing structure complexity and sensitivity of the transition to manufacturing error. Finally, the presence of the dielectric board inside the waveguide channel leads to additional signal loss related to dielectric loss in the substrate.

Yet another waveguide-to-microstrip transition is known from the paper “Wideband Tapered Antipodal Fin-Line Waveguide-to-Microstrip Transition for E-band Applications” written by Mozharovskiy A., Artemenko A., Ssorin V., Maslennikov R., Sevastyanov A., published in proc. of 43rd European Microwave Conference, 6-10 October 2013. In this transition, a dielectric board with a printed microstrip line is clamped between two metal parts forming a waveguide channel along the transmission line. Owing to such an arrangement, the transition experiences high level of parasitic radiation from the board end face that leads to significant insertion loss. Moreover, the need for manufacturing two metal parts forming a waveguide channel leads to strict requirements for flatness and surface roughness which lead to an increase in manufacturing costs.

The closest prior-art of the present invention is a waveguide-to-microstrip transition described in the U.S. Pat. No. 6,967,542 filed on Dec. 30, 2004. The prior-art transition is composed of a dielectric board with a microstrip line and a microstrip probe which is placed between an input waveguide and a short-circuited waveguide of similar cross-section profile. The shorted waveguide is located at the same board side with the line and the probe. At the same time, the input waveguide which is often formed by the interface of a specific bulky radio communications device is arranged on the microstrip ground side of the board. Such mutual arrangement of the transition elements provides enough space on the board for IC integration, with such ICs connectable to the microstrip line. The input waveguide piece can comprise a flange arranged on the dielectric board and providing electrical contact between the waveguide and the microstrip ground directly or via through-holes made in the board.

The main drawback of the prior-art transition is the emergence of an equivalent LC circuit (resonant circuit) formed by the waveguides and a portion of the dielectric board that is located inside the waveguide channel. The resonant nature of the LC circuit limits the operational bandwidth of the device and therefore necessitates the use of additional features on the board providing an extension of the transition operational bandwidth. For example, in the prior-art transition, a microstrip quarter-wave impedance transformer, different matching microstrip stubs etc. are utilized for this purpose. These elements significantly complicate the transition design and decrease manufacturing tolerances. Another disadvantage is an increase in insertion loss between the line and the waveguide which is caused by the presence of the dielectric board substrate in the waveguide channel area.

Thus, there is a need for a probe-type waveguide-to-microstrip line transition providing a wide operational bandwidth and low insertion loss with a structure that does not contain any parasitic capacitance of the impedance between the probe and the waveguide channel. In such a transition, there is no need for special parasitic capacitance compensation techniques, thus significantly simplifying device structure, easing the precision requirements in manufacturing and mutual positioning of the board with the microstrip line with respect to the waveguide channel.

### SUMMARY OF THE INVENTION

The object of the present invention is to provide a probe-type waveguide-to-microstrip transition with wide bandwidth and low insertion loss, the transition comprising a structure which does not produce parasitic capacitance of the impedance between the probe and the waveguide channel.

The invention provides the following advantages: a decrease in insertion loss and an extended operational bandwidth with a low wave reflection coefficient of the waveguide-to-microstrip transition.

The object is achieved by a waveguide-to-microstrip transition comprising an input waveguide piece having a through-hole defining an open waveguide channel, a short-circuited waveguide piece having a blind cavity defining a closed waveguide channel, and a dielectric board placed between the waveguides pieces; wherein the top surface of the dielectric board comprises a microstrip transmission line, a microstrip probe formed as an extension of the microstrip transmission line, and a contact metal layer are located on a top surface of the dielectric board, wherein the contact metal layer, wherein the contact metal layer surrounds the microstrip probe with no electrical connection to the microstrip probe and the microstrip transmission line and forms an internal area on the dielectric board, the internal area being a waveguide channel area; wherein the short-circuited waveguide piece is located on the contact metal layer and has a recess in the area of the microstrip transmission line, while the bottom surface of the dielectric board comprises a ground metal plane surrounding the waveguide channel area, the input waveguide piece being mounted on the ground metal plane, wherein at least one metallized transition through-hole is provided along the circumference around the waveguide channel area in the metal layers and in the dielectric board, and wherein at least one non-metallized through-hole is provided within the waveguide channel area on the dielectric board.

The dielectric board and the metal layers have metallized mounting through-holes to provide connection of the board and the waveguides pieces.

At least one metallized transition through-hole can be configured to electrically connect the contact metal layer and the ground metal plane with the waveguides pieces.

The dielectric board can comprise at least two dielectric layers with a ground metal plane in-between, the ground metal plane being a ground lead of the microstrip transmission line.

The microstrip probe has a circular, sectoral, rectangular or trapezoidal longitudinal section.

The waveguide channel has a rectangular, circular or elliptical cross-section.

The closed waveguide channel of the short-circuited waveguide piece has a rectangular, circular or trapezoidal longitudinal cross-section.

In one embodiment, at least one non-metallized through-hole is symmetrically located at each side of the probe within the waveguide channel area on the dielectric board.

A non-metallized through-hole is arranged within the waveguide channel area on the dielectric board, said hole having a perimeter substantially matching the overall section of the waveguide channel area not occupied by the probe.

The input waveguide piece is electrically connectable with a horn antenna.

The input waveguide piece is electrically connectable with a diplexer.

The dielectric board is fabricated using technology selected from a group consisting of: printed circuit board technology; low temperature co-fired ceramic technology; laser transfer printing technology; thin-film technology; liquid crystal polymer technology.

The waveguides pieces are made of a dielectric material covered with metal.

The waveguides pieces are made of metal.

The open and closed waveguide channels are partially or fully filled with a dielectric material.

An integrated circuit is mounted on the dielectric board and configured to electrically connect to the input microstrip transmission line by means of surface-mount technology.

The dielectric board has a special cavity provided for an integrated circuit to be mounted therein.

### BRIEF DESCRIPTION OF THE DRAWINGS

Further features and advantages of the present invention will become apparent from the following description of the preferred embodiments with reference to accompanying drawings.

FIG. 1 illustrates a waveguide-to-microstrip transition realized on the board that consists of a single dielectric layer according to the present invention:

a) a general view of the transition;

b) a longitudinal cross-section made along the A-A′ line;

c) a top view of the dielectric board;

d) a bottom view of the dielectric board.

FIG. 2 shows a waveguide-to-microstrip transition with a dielectric board having two dielectric layers according to the present invention:

a) a general view of the transition;

b) a longitudinal section made along the A-A′ line;

c) a top view of the dielectric board;

d) a top view of the ground metal layer placed between two dielectric layers of the dielectric board;

e) a bottom view of the dielectric board.

### LIST OF REFERENCE NUMERALS:

1—dielectric board;

2—input waveguide piece;

3—short-circuited waveguide piece;

4—microstrip transmission line;

5—microstrip probe;

6—open waveguide channel;

7—closed waveguide channel;

8—contact metal layer;

9—waveguide channel area;

10—recess;

11—metallized transition through-hole;

12—non-metallized through-hole;

13—metallized mounting through-holes;

14—first dielectric layer;

15—second dielectric layer;

16—ground metal plane;

17—input waveguide piece mounting holes;

18—short-circuited waveguide piece mounting holes;

19—mounting elements.

### DETAILED DESCRIPTION OF THE INVENTION

A waveguide-to-microstrip transition comprises an input waveguide piece 2 having a through-hole defining an open waveguide channel 6, a short-circuited waveguide piece 3 having a blind cavity defining a closed waveguide channel 7, and a dielectric board 1 placed between the waveguides pieces 2, 3. The top surface of the dielectric board 1 comprises a microstrip transmission line 4, a microstrip probe 5 formed as an extension of the microstrip transmission line 4, and a contact metal layer 8 surrounding the microstrip probe 5 with no electrical connection to the microstrip probe 5 and the microstrip transmission line 4, wherein the contact metal layer 8 forms an internal area on the dielectric board 1, the internal area being a waveguide channel area 9.

The waveguide short-circuited piece 3 is located on the contact metal layer 8 and has a recess 10 in the area of the microstrip transmission line 4, while the bottom surface of the dielectric board 1 comprises a ground metal plane 16 surrounding the waveguide channel area 9, the input waveguide piece 2 being mounted on the ground metal plane 16.

At least one metallized transition through-hole 11 is provided along the circumference around the waveguide channel area 9 in the metal layers and in the dielectric board 1, and at least one non-metallized through-hole 12 is provided within the waveguide channel area 9 on the dielectric board 1.

The dielectric board 1, the contact metal layer 8 and the ground metal plane 16 include metallized mounting through-holes 13 which can be used to connect the dielectric board 1 with the input waveguide piece 2 and the short-circuited waveguide piece 3.

At least one metallized transition through-hole 11 can be configured to electrically connect the contact metal layer 8 and the ground metal plane 16 with the input waveguide piece 2 and the short-circuited waveguide piece 3.

The dielectric board 1 can comprise at least two dielectric layers, a first dielectric layer 14 and a second dielectric layer 15, with a ground metal plane 16 in-between, the ground metal plane 16 is a ground lead of the microstrip transmission line 4.

The microstrip probe 5 has a circular, sectoral, rectangular or trapezoidal longitudinal section.

The waveguide channel 6 has a rectangular, circular or elliptical cross-section.

The closed waveguide channel 7 has a rectangular, circular or trapezoidal longitudinal cross-section.

At least one non-metallized through-hole 12 is symmetrically located at each side of the microstrip probe 5 within the waveguide channel area 9 of the dielectric board 1.

The non-metallized through-hole 12 is arranged within the waveguide channel area 9 on the dielectric board 1, said hole having a perimeter substantially matching the overall section of the waveguide channel area 9 not occupied by the microstrip probe 5.

The input waveguide piece 2 can be electrically connected with a horn antenna.

The input waveguide piece 2 can be electrically connected with a diplexer.

The dielectric board 1 is fabricated using technology selected from a group consisting of: printed circuit board technology; low temperature co-fired ceramic technology; laser transfer printing technology; thin-film technology; liquid crystal polymer technology.

The input waveguide piece 2 and the short-circuited waveguide piece 3 can be made of a dielectric material covered with metal.

The input waveguide piece 2 and the short-circuited waveguide piece 3 can be made of metal.

The open waveguide channel 6 and the closed waveguide channel 7 are partially or fully filled with a dielectric material.

An integrated circuit is mounted on the dielectric board 1 and configured to electrically connect to the microstrip transmission line 4 by means of surface-mount technology.

The dielectric board 1 has a special cavity provided for an integrated circuit to be mounted therein.

The transition operates as follows.

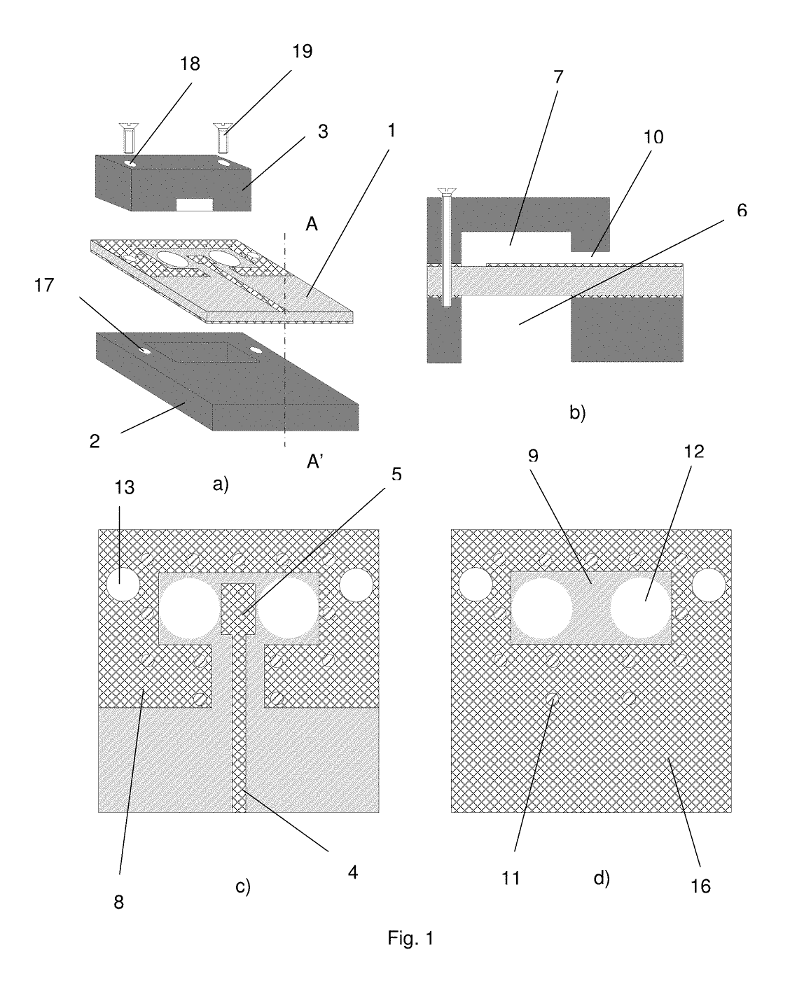

With reference to FIG. 1, for accurate mutual positioning of the transition components, the single-layer dielectric board 1 with the microstrip transmission line 4 and the microstrip probe 5 and the contact metal layer 8 surrounding the microstrip probe 5 and the microstrip transmission line 4 at the top surface of the dielectric board 1 and with the ground metal plane 16 surrounding the waveguide channel area 9 is placed between the input waveguide piece 2 and the short-circuited waveguide piece 3 with the help of fixing elements 19 and corresponding metallized mounting through-holes 13 provided in the dielectric board 1 in the contact metal layer 8 and the ground metal plane 16 and with the help of the input waveguide piece mounting holes 17 and the waveguide short-circuited piece mounting holes 18.

In a single-layer dielectric board 1, the contact metal layer 8 and the ground metal plane 16 at the periphery of the waveguide channel area 9 have metallized transition through-holes 11 for electrical connection of the ground metal plane 16 of the microstrip transmission line 4 with the input waveguide piece 2 and the short-circuited waveguide piece 3.

To reduce the capacitive part of the impedance reactance between the microstrip probe 5 and the waveguide channel 6 which is brought by the dielectric board 1, two non-metallized through-holes 12 with circular shape are provided in the dielectric board 1.

The diameter of non-metallized through-holes 12 in the dielectric board 1 is as large as possible with respect to the dielectric board 1 manufacturing technology but limited by the waveguide channel size. This allows effective removal of parasitic capacitance of the reactance, with the shape and the size of the microstrip probe 5 selected to achieve impedance matching in required frequency band. Thus, such implementation allows achieving high level of transition performance. At the same time, it is clear that large non-metallized through-holes 12 can be replaced with a plurality of holes having a smaller diameter.

A microwave signal is applied to the microstrip transmission line 4 where it propagates as quasi-TEM mode of electromagnetic waves. The signal passing through the microstrip transmission line 4 reaches the waveguide channel area 9 of the dielectric board 1 where the microstrip probe 5 serves as matching element between the input waveguide piece 2 and the short-circuited waveguide piece 3 and the microstrip transmission line 4. In the waveguide channel area 9, a portion of the signal is radiated into the waveguide channel 6 of the input waveguide piece 2 by the microstrip probe 5.

The remaining portion of the signal is radiated into the closed waveguide channel 7 of the short-circuited waveguide piece. The distance between the microstrip probe 5 and short-circuiting of the closed waveguide channel 7 of the short-circuited waveguide piece is about a quarter of the electrical wavelength, thus providing coherent in-phase addition of the direct electromagnetic wave radiated into the waveguide channel 6 and the electromagnetic wave reflected back from the channel 7 of the short-circuited waveguide piece. Then the total signal propagates through the waveguide channel 6 of the input waveguide piece 2 in the form of TE10 waveguide mode.

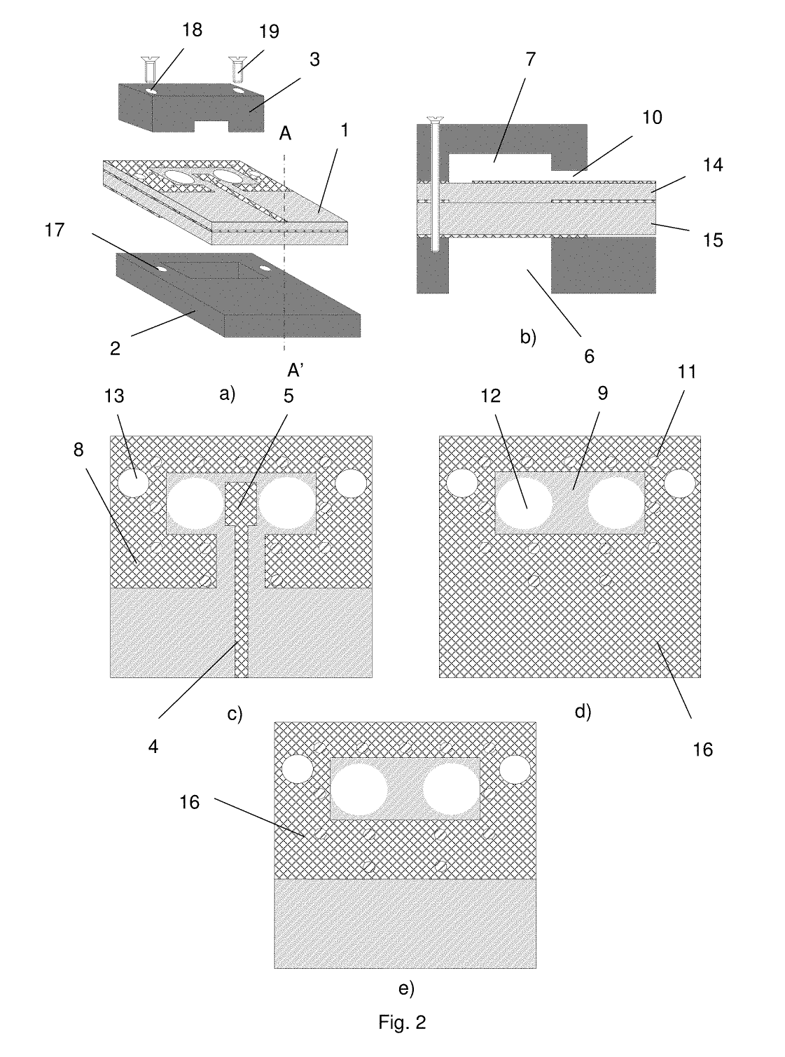

The dielectric board of the proposed transition can be multilayer which is required when either of IC integration on the board, development of high-density printed circuits or implementation of different multi-layer passive devices (antennas, cross-connections) is necessary. For example, a waveguide-to-microstrip transition according to one of the embodiments of the invention with the board comprising two dielectric layers is shown in FIG. 2.

The transition contains the dielectric board 1 with two dielectric layers 14, 15 placed between the input waveguide piece 2 and the short-circuited waveguide piece 3 which include the open waveguide channel 6 and the closed waveguide channel 7. The ground metal plane 16 surrounding the waveguide channel area 9 is located between the first dielectric layer 14 and the second dielectric layer 15 and in this case it is the microstrip transmission line 4 ground lead.

The top side of the first dielectric layer 14 of the dielectric board 1 comprises the microstrip transmission line 4, the microstrip probe 5 and the contact metal layer 8 surrounding the microstrip probe 5 and the microstrip transmission line 4, while the bottom side of the second dielectric layer 15 of the dielectric board 1 includes ground metal plane 16 surrounding the waveguide channel area 9. The dielectric board 1 with the first dielectric layer 14, the second dielectric layer 15, the contact metal layer 8 and the ground metal plane 16 have transition metallized through-holes 11 along the circumference of the waveguide channel area 9 for electrical connection of the contact metal layer 8 and the ground metal plane 16 with the input waveguide piece 2 and the short-circuited waveguide piece 3.

It should be mentioned that the dielectric board 1 of the transition can have more than two dielectric layers, and the ground lead of the microstrip transmission line 4 can be realized at the bottom side of the board or in some of its inner ground planes.

Transition characteristics for operation in specific frequency bands can be tuned by picking various probe shapes (circular, sectoral, trapezoidal) and parameters of non-metallized through-holes 12 in the waveguide channel area 9 on the dielectric board 1, for example, symmetrically at each side of the microstrip probe 5 or with the size that coincides with the waveguide channel area 9 non-occupied by the microstrip probe 5. In some cases, when bandwidth broadening is required, the board can be provided with additional features: a microstrip quarter-wave impedance transformer, different matching microstrip stubs, etc.

Wideband characteristics matching of the transition is possible if the length of the shorted waveguide channel is equal to about a quarter of the waveguide wavelength. In some specific cases this length can be different, with the length value obtained from electromagnetic simulation results to achieve the best performance of the transition. Said values typically range from zero to half the operational wavelength.

The proposed transition may be used, for instance, in transceiver devices of modern millimeter-wave radio-relay communication systems. In particular, transmitter and receiver of a radio transceiver module for radio-relay communications can be implemented on multi-layer dielectric boards based on PCB technology. Radio receiver and transmitter ICs can be mounted in cavities in the boards and can be electrically connected with pads and transmission lines on the board by means of wire-bonding technology or using the flip-chip method. Each board can contain a waveguide-to-microstrip transition according to one of the embodiments of the preferred invention.

Such transitions are utilized for electromagnetic transmission between a waveguide and a microstrip line. Waveguide outputs of the transitions can be parts of a waveguide diplexer that allows separating received and transmitted signal to closely spaced frequency bands. In another particular case, the waveguide output may be the input port of a horn antenna or any other antenna with a waveguide input interface.

The disclosed waveguide-to-microstrip transition can operate in various frequency bands within the 50-100 GHz band or higher, for example in the 57-66 GHz and 71-86 GHz bands. These are the most promising bands in terms of implementing various radio communication systems with high data throughput. That makes the disclosed transition promising for utilization in different modern millimeter-wave devices and applications.

Experiments showed that the proposed transition provides less than 1 dB of signal transmission loss and a 71-86 GHz bandwidth of the reflection coefficient below −20 dB in the whole band, while the closest analogue exhibits signal transmission loss of about 1.5 dB and aforementioned reflection coefficient below −20 dB only for the 8 GHz band that does not cover the entire 71-86 GHz band.

Thus, the proposed invention allows obtaining probe-type waveguide-to-microstrip transition with wide bandwidth, low reflection coefficient, and low signal loss, with a structure that does not introduce parasitic capacitance of the impedance between the probe and the waveguide channel.

The invention was disclosed with the reference to a specific embodiment. Other embodiments of the invention will be evident to those skilled in the art without departing from the scope and spirit of the present invention. Therefore, the invention is intended to be limited only by the appended claims.

1. A waveguide-to-microstrip transition comprising: an input waveguide piece having a through-hole defining an open waveguide channel, a short-circuited waveguide piece having a blind cavity defining a closed waveguide channel, and a dielectric board placed between the waveguides pieces; wherein a microstrip transmission line, a microstrip probe formed as an extension of the microstrip transmission line, and a contact metal layer are located on a top surface of the dielectric board, wherein the contact metal layer surrounds the microstrip probe with no electrical connection to the microstrip probe and the microstrip transmission line and forms an internal area on the dielectric board, the internal area being a waveguide channel area; wherein the short-circuited waveguide piece is located on the contact metal layer and has a recess in the area of the microstrip transmission line, wherein a ground metal plane surrounding the waveguide channel area is located on a bottom surface of the dielectric board, the input waveguide piece being mounted on the ground metal plane, wherein at least one metallized transition through-hole is provided along the circumference around the waveguide channel area in the metal layers and in the dielectric board, and wherein at least one non-metallized through-hole is provided within the waveguide channel area on the dielectric board.

2. The transition according to claim 1, wherein the dielectric board and the metal layers have metallized mounting through-holes to provide connection of the board and the waveguides pieces.

3. The transition according to claim 1, wherein at least one metallized transition through-hole is configured to electrically connect the contact metal layer and the ground metal plane with the waveguides pieces.

4. The transition according to claim 1, wherein the dielectric board includes at least two dielectric layers with a ground metal plane in-between, the ground metal plane being a ground lead of the microstrip transmission line.

5. The transition according to claim 1, wherein the microstrip probe has a circular, sectoral, rectangular or trapezoidal longitudinal section.

6. The transition according to claim 1, wherein the waveguide channel has a rectangular, circular or elliptical cross-section.

7. The transition according to claim 1, wherein the closed waveguide channel has a rectangular, circular or trapezoidal longitudinal cross-section.

8. The transition according to claim 1, wherein at least one non-metallized through-hole is symmetrically located at each side of the microstrip probe within the waveguide channel area on the dielectric board.

9. The transition according to claim 1, wherein a non-metallized through-hole is arranged within the waveguide channel area on the dielectric board, said hole having a perimeter substantially matching the overall section of the waveguide channel area not occupied by the microstrip probe.

10. The transition according to claim 1, wherein the input waveguide piece is electrically connectable with a horn antenna.

11. The transition according to claim 1, wherein the input waveguide piece is electrically connectable with a diplexer.

12. The transition according to claim 1, wherein the dielectric board is fabricated using technology selected from a group comprising: printed circuit board technology; low temperature co-fired ceramic technology; laser transfer printing technology; thin-film technology; liquid crystal polymer technology.

13. The transition according to claim 1, wherein the waveguides pieces are made of a dielectric material covered with metal.

14. The transition according to claim 1, wherein the waveguides pieces are made of metal.

15. The transition according to claim 1, wherein the open and closed waveguide channels are partially or fully filled with a dielectric material.

16. The transition according to claim 1, wherein an integrated circuit is mounted on the dielectric board, the integrated circuit is configured to electrically connect to the input microstrip transmission line by means of surface-mount technology.

17. The transition according to claim 16, wherein the dielectric board has a special cavity in it provided for an integrated circuit to be mounted therein.
